(19) United States
(12) Patent Application Publication
(10) Pub. No.: US 2012/0307255 A1
(43) Pub. Date: Dec. 6, 2012

(54) OPTICAL INTERFEROMETER SYSTEM WITH DAMPED VIBRATION AND NOISE EFFECT PROPERTY

(76) Inventors: Chang Seok KIM, Busan (KR); Myung Yung Jeong, Busan (KR); Jae Seok Park, Gimhae-si (KR)

(21) Appl. No.: 13/288,387

(22) Filed: Nov. 3, 2011

(30) Foreign Application Priority Data
May 30, 2011 (KR) 10-2011-0051431

(51) Int. Cl. G01B 9/02

(52) U.S. Cl. 356/477

(57) ABSTRACT

The present invention relates to an optical interferometer system with a damped vibration and noise effect property, in which a direct attachment of a partial reflecting film and an object to be measured may be used to damp a vibration and noise effect, thereby implementing a high-resolution optical shape measuring system. The optical interferometer system comprises an optical interferometer having a reference signal generating means attached to be spaced apart from an object to be measured by a predetermined distance, wherein the optical interferometer allows a reference signal and a measuring signal reflected from each boundary surface of the object to be measured to have an identical vibration and noise so that the vibrations and noises of the reference and measuring signals are canceled from each other; and a light receiving unit for measuring the object to be measured using an optical inference signal transmitted from the optical interferometer.

### BACKGROUND OF THE INVENTION

1. Field of the Invention

The present invention relates to an optical interferometer, and more particularly, to an optical interferometer system with a damped vibration and noise effect property, in which a direct attachment of a partial reflecting film to an object to be measured may be used to damp a vibration and noise effect, thereby implementing a high-resolution optical shape measuring system.

2. Description of the Related Art

Generally, an optical interferometer is a device for precisely measuring the wavelength, surface inhomogeneous property (refractive index), etc. of a light flux. After the light flux passes through the optical interferometer, the light flux is divided into two light fluxes. The two light fluxes travel along their respective paths, whose distances are different from each other, and then are converged into a single point, in which the two light fluxes are interfered with each other, so that the intensity of the interfered light flux may be increased or decreased.

This interference phenomenon results in a stripped pattern having a plurality of light and dark strips, which is also referred to as an interference fringe. Information measured from such a stripped pattern may be used to perform a precise determination of the wavelength, a measurement of very fine distance and thickness, a study of the spectral line, a calculation of the refractive index of a transparent material, etc.

The system for measuring fine height variations in a surface of the object to be measured using the interference phenomenon of the optical signal as describe above has a disadvantage in that a position at which an optical signal is generated from a reference stage is substantially spaced apart from another position at which another optical signal is generated from the object to be measured (sample), so that a signal distortion may be generated due to vibrations or environmental variation noises.

That is, if separate optical paths as illustrated in a Michelson or Mach-Zehnder type optical interferometer are used, the intrinsic structure of such an optical interferometer allows a reference signal from the reference stage and a sample signal from the sample stage to travel along their respective separate optical paths and then to be converged to form an interference fringe. In this case, the reference signal and the sample signal are reflected on their respective separate optical paths, and then they are subject to different vibrations and noises, respectively, so that the signal distortion may be involved.

Further, if a Fizeau type optical interferometer is used in order to use a common optical path, vibrations and noises may be relatively further reduced. However, since a partial reflecting film served as the reference stage is still fixedly attached to an optical interference microscope and the object to be measured is still spatially separated from the Fizeau type optical interferometer, vibrations and noises still remain.

### SUMMARY OF THE INVENTION

Accordingly, the present invention is conceived to solve the aforementioned problems in the prior art. An object of the present invention is to provide an optical interferometer system with a damped vibration and noise effect property, in which a direct attachment of a partial reflecting film to an object to be measured may be used to damp a vibration and noise effect, thereby implementing a high-resolution optical shape measuring system.

Another object of the present invention is to provide an optical interferometer system with a damped vibration and noise effect property, in which a partial reflecting film and an object to be measured may be separated from each other using a space-separating attaching device to form an optical path difference, thereby measuring a height structure of a surface of the sample and an internal shape thereof.

Further object of the present invention is to provide an optical interferometer system with a damped vibration and noise effect property, in which a reference stage and a sample stage exist in a spatially-identical space, so that they may be subject to an identical vibration or environmental variation, thereby effectively removing vibrations and noises of the optical interferometer.

Still further object of the present invention is to provide an optical interferometer system with a damped vibration and noise effect property, in which a partial reflecting film and a sample (object to be measured) are separated from each other using a space-separating attaching device attached onto a surface of the object to be measured, so that vibrations and noises may be effectively damped, thereby measuring the height structure of the surface of the object to be measured.

Still further object of the present invention is to provide an optical interferometer system with a damped vibration and noise effect property, in which a reference reflecting film is positioned on the opposite surface of a sample stage to obtain the thickness information of a sample, or two opposite surfaces of the sample stage are used to obtain the thickness information of the sample.

The objects of the present invention is not limited those as described above, and it will be appreciated that other objects of the present invention which have not been described herein will be apparently understood to a person skilled in the art.

According to an aspect of the present invention for achieving the objects, there is provided an optical interferometer system with a damped vibration and noise effect property, which comprises an optical interferometer having a reference signal generating means attached to be spaced apart from an object to be measured by a predetermined distance, wherein the optical interferometer allows a reference signal and a measuring signal reflected from each boundary surface of the object to be measured to have an identical vibration and noise so that the vibrations and noises of the reference and measuring signals are canceled from each other; and a light receiving unit for measuring the object to be measured using an optical inference signal transmitted from the optical interferometer.

According to another aspect of the present invention, there is provided an optical interferometer system with a damped vibration and noise effect property, which comprises an optical interferometer having a reference signal generating means attached to be spaced apart from an object to be measured by a predetermined distance, wherein the optical interferometer allows a reference signal and a measuring signal reflected from each boundary surface of the object to be measured to have an identical vibration and noise so that the vibrations and noises of the reference and measuring signals are canceled from each other; a secondary interferometer for generating an optical interference to compensate for an optical path difference generated by the optical interferometer; and a light receiving unit for measuring the object to be measured using optical inference signals transmitted from the optical interferometer and the secondary interferometer.

Here, the reference signal generating means is a partial reflecting film for reflecting a portion of an optical signal transmitted from its outside to generate the reference signal, the partial reflecting film allowing the other portion of the optical signal to pass therethrough to thereby generate the measuring signal reflected from at least one boundary surface among an exterior surface and an interior surface of the object to be measured.

Further, the optical interferometer further includes an optical coupler for outputting light onto the object to be measured, and the reference signal generating means is located at a position which is relatively closer to a spatial vibration tendency of the object to be measured rather than a spatial vibration tendency of the optical coupler.

Here, the optical interferometer system further comprises a space-separating attaching means for attaching the reference signal generating means to be spaced apart from the object to be measured by a predetermined distance, wherein the space-separating attaching means directly attaches the reference signal generating means and the object to be measured or attaching the reference signal generating means and a support on which the object to be measured is located.

In addition, if an optical path difference between the reference signal and the measuring signal is larger than a pseudo interference distance of a light source, the secondary interferometer additionally compensates for the optical path difference to generate an optical interference.

According to a further aspect of the present invention, there is provided an optical interferometer system with a damped vibration and noise effect property, which comprises a first optical interferometer having a reference signal generating means attached to a first surface of an object to be measured to be spaced apart by a predetermined distance, the first optical interferometer allowing a reference signal and a measuring signal reflected from each boundary surface of the object to be measured to have an identical vibration and noise so that the vibrations and noises of the reference and measuring signals are canceled from each other; a second optical interferometer configured on a second surface opposite to the first surface of the object to be measured, thereby illuminating the second surface of the object to be measured with an optical signal transmitted from a light source; and a light receiving unit for measuring the object to be measured using optical inference signals transmitted from the first and second optical interferometers.

According to a still further aspect of the present invention, there is provided an optical interferometer system with a damped vibration and noise effect property, which comprises a first optical interferometer configured on a first surface of an object to be measured, thereby illuminating the first surface of the object to be measured with an optical signal transmitted from a light source; a second optical interferometer configured on a second surface opposite to the first surface of the object to be measured, thereby illuminating the second surface of the object to be measured with an optical signal transmitted from a light source; and a light receiving unit for measuring the object to be measured using optical inference signals transmitted from the first and second optical interferometers, wherein the first surface of the object to be measured, which is illuminated with the optical signal from the first optical interferometer, and the second surface of the object to be measured, which is illuminated with the optical signal from the second optical interferometer, are used as reference signal generating means for generating an optical interference.

According to a still further aspect of the present invention, there is provided an optical interferometer system with a damped vibration and noise effect property, which comprises a first optical interferometer configured on a first surface of an object to be measured, thereby illuminating the first surface of the object to be measured with an optical signal transmitted from a light source; a second optical interferometer configured on a second surface opposite to the first surface of the object to be measured, thereby illuminating the second surface of the object to be measured with an optical signal transmitted from a light source; a secondary interferometer for generating an optical interference to compensate for optical path differences generated by the first and second optical interferometers; and a light receiving unit for measuring the object to be measured using optical inference signals transmitted from the first and second optical interferometers and the secondary interferometer, wherein the first surface of the object to be measured, which is illuminated with the optical signal from the first optical interferometer, and the second surface of the object to be measured, which is illuminated with the optical signal from the second optical interferometer, are used as reference signal generating means for generating an optical interference.

### BRIEF DESCRIPTION OF THE DRAWINGS

FIG. 1 is a configuration diagram of an optical fiber based optical interference microscope system for effectively reducing vibration and noise;

FIG. 2 is a configuration diagram illustrating a direct attachment of a partial reflecting film to an object to be measured using a space-separating attaching device;

FIG. 3 is a configuration diagram of an optical interference microscope system having an additional interferometer for compensating for an optical path difference;

FIG. 4 is a configuration diagram of a free-space optical system based optical interference microscope system for effectively reducing vibration and noise;

FIG. 5 is a configuration diagram of a free-space optical system based optical interference microscope system having an additional interferometer for compensating for an optical path difference;

FIG. 6 is a configuration diagram of an optical interferometer system, in which an additional reference reflecting film is attached onto an opposite surface of a sample using a space-separating attaching device, so that an optical path difference is formed to measure a surface structure of the sample and an internal shape thereof;

FIG. 7 is a configuration diagram of an optical interferometer system, in which two opposite surfaces of a sample to be measured are used as two reflecting reference films for generating an optical interference, so that a thickness structure of the sample is measured; and

FIG. 8 is a configuration diagram of an optical interference thickness measuring system having an additional interferometer for compensating for an optical path difference.

### DESCRIPTION OF THE PREFERRED EMBODIMENT

Hereinafter, a preferred embodiment of an optical interferometer system with a damped vibration and noise effect property according to the present invention will be described in detail with reference to the accompanying drawings. Throughout the drawings, like reference numerals are used to designate like elements.

The features and advantages of an optical interferometer system with a damped vibration and noise effect property according to the present invention will be clearly understood through the detailed descriptions for the respective embodiments as described below.

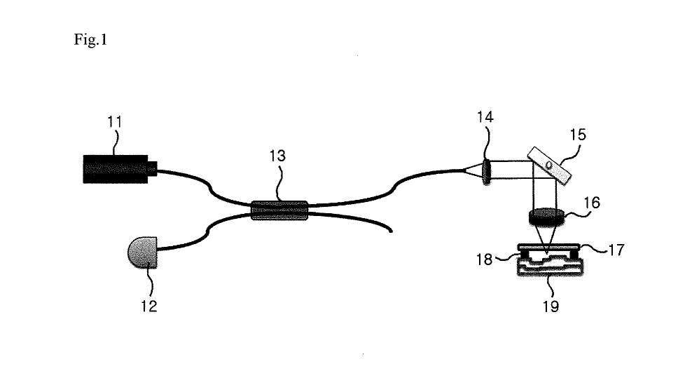

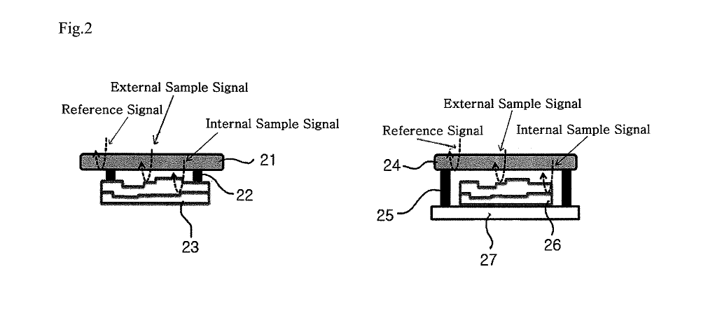

FIG. 1 is a configuration diagram of an optical fiber based optical interference microscope system for effectively reducing vibration and noise, and FIG. 2 is a configuration diagram illustrating a direct attachment of a partial reflecting film to an object to be measured using a space-separating attaching device.

An optical interferometer system with a damped vibration and noise effect property according to the present invention relates to an optical interferometer system, in which a partial reflecting film is separated from a sample to be measured using a space-separating attaching device, so that an optical path difference is formed to measure a height structure of a surface of the sample and an internal shape thereof.

The partial reflecting film and the sample (object) to be measured are integrally formed according to the present invention, so that a reference stage and a sample stage may be subject to an identical vibration or environmental variation, thereby preventing vibration and noise.

Hereinafter, the object to be measured includes all objects such as a substrate, a chip, a PCB, a human body, etc., which are required to be measured for the shape of a surface thereof, the depth and the thicknesses, etc.

FIG. 1 represents a configuration of an optical fiber based optical interference microscope system, in which a partial reflecting film 17 is separated from an object 19 to be measured using a space-separating attaching device 18, so that an optical path difference may be formed to measure a height structure of a surface of the object 19 to be measured and an internal shape thereof.

As shown in FIG. 1, the optical fiber based optical interference microscope system is configured to include a light source unit 11, a light receiving unit 12, an optical coupler 13, a collimator 14, a beam-position transferring mirror 15, an objective lens 16, the partial reflecting film 17, the space-separating attaching device 18, and the object 19 to be measured.

Here, the light source unit 11 and the optical coupler 13, the optical coupler 13 and the collimator 14, and the optical coupler 13 and the light receiving unit 12 are connected to each other using optical fibers, respectively.

The light source unit 11 may be a super luminescent diode (SLD) which may have any central wavelength and a minimal wavelength bandwidth capable of identifying the thickness of a sample.

The optical coupler 13 is connected to the light source unit 11, the collimator 14 and the light receiving unit 12 using the optical fiber, so that the optical coupler 13 is used to distribute or combine optical signals transmitted through the optical fiber. That is, the optical coupler 13 allows an optical signal emitted from the light source unit 11 to be transmitted to the collimator 14, and allows a reference signal, an external sample signal and an internal sample signal, reflected from respective boundary surfaces of the object 19, to be measured and outputted outwards to be transmitted to the light receiving unit 12.

The collimator 14 converts the optical signal transmitted through the optical coupler 13 to a collimated light or focuses the optical signal reflected from the object 19 to be measured.

Further, the beam-position transferring mirror 15 configured between the collimator 14 and the object 19 to be measured is used to change an illumination position of the optical signal collimated and transmitted from the collimator 14.

In addition, the objective lens 16 is provided to focus the optical signal transmitted with the illumination position thereof changed and then to illuminate the object 19 to be measured, and the partial reflecting film 17 is provided between the objective lens 16 and the object 19 to be measured.

Here, the partial reflecting film 17 is integrated with the object 19 to be measured using the space-separating attaching device 18, so as to generate the reference signal.

The light receiving unit 12 is connected to the optical coupler 13, and measures the height structure of the surface of the object 19 to be measured and the internal shape thereof from an interference spectrum of the object 19 to be measured, which is generated due to the optical path differences between the optical signal reflected from the partial reflecting film 17 and the reference signal, the external sample signal and the internal sample signal reflected from respective boundary surfaces of the object 19 to be measured and outputted outwards.

Here, one surface of the partial reflecting film 17 for generating the reference signal is coated with an anti-reflection film so that there is no reflection from the one surface, whereas the other surface has a reflectivity enough to be required for the system so that a partial reflection may be generated from the other surface.

The other light transmitted through the partial reflecting film 17 is reflected from the sample, i.e., the object 19 to be measured, to form a sample signal.

That is, the partial reflecting film 17 is served as a reference signal generating means, by which a portion of the optical signal transmitted from its outside is reflected to generate the reference signal and the other portion of the optical signal is transmitted to generate a measuring signal which will be reflected from at least one boundary surface among external or internal surfaces of the object to be measured.

In an optical interferometer system as illustrated in FIG. 1, a delay time may be generated depending on the reflecting position between the partial reflecting film 17 and the sample, so that an interference fringe may be seen in the light receiving unit 12 if it is measured.

Any fine height variation in the sample results in a fine variation in size and phase of the optical interference fringe measured in the light receiving unit 12, so that a high resolution optical shape measuring system may be implemented.

The optical interferometer system according to the present invention is located at a position which is relatively closer to a spatial vibration tendency of the sample stage rather than a spatial vibration tendency of the optical coupler 13 in order to be less sensitive to vibration and noise resulting from vibrations or environmental variations during the measurement of the difference between two optical paths.

Particularly, the optical interferometer system according to the present invention may be configured to integrate the reference stage and the sample stage so that the reference signal and the sample signal have an identical vibration and noise in order to be less sensitive to vibration and noise resulting from vibrations or environmental variations during the measurement of the difference between two optical paths.

The integrated configuration of the reference stage and the sample stage using the space-separating attaching device as described above may be implemented with two different schemes as shown in FIG. 2.

First, a space-separating attaching device 22 is directly attached on a surface of an object 23 to be measured, in which the space-separating attaching device 22 allows a partial reflecting film 21 to be separated from the object 23 to be measured, so that the vibration and noise may be effectively damped to measure the height structure of the surface of the sample.

Second, a space-separating attaching device 25 is attached to a support 27 on which an object 26 to be measured is located, in which the space-separating attaching device 25 allows a partial reflecting film 24 to be separated from the object 23 to be measured, the vibration and noise may be effectively damped to measure the height structure of the surface of the sample.

As described above, the space-separating attaching device is used to vibrationally integrate the partial reflecting film and the object to be measured and to adjustably generate the optical path difference, so that, if the optical interference signal is measured, the effect due to the vibration and noise may be canceled from each other, thereby realizing a precise measurement.

Further, if the reflection of the object to be measured is simultaneously generated from the inside of the object to be measured as well as the surface of the object to be measured, a tomographic image as well as an optical surface shape may be implemented.

In this case, all the respective optical interferences allow the vibration and noise to be effectively restrained.

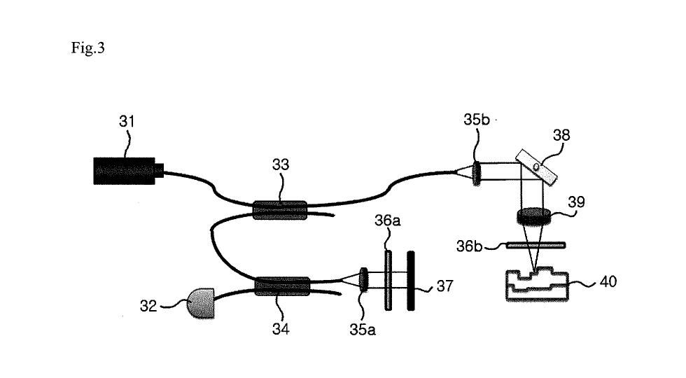

As shown in FIG. 3, if the optical path difference between the reference signal and the measuring signal from the sample is larger than a pseudo interference distance of a light source, the optical path difference is additionally compensated, so that the optical interferometer may be configured to generate an effective optical interference.

FIG. 3 is a configuration diagram of an optical interference microscope system having an additional interferometer for compensating for an optical path difference.

As shown in FIG. 3, the optical interference microscope system is configured to include a light source unit 31, an optical coupler 33, a second collimator 35b, a beam-position transferring mirror 38, an objective lens 39, and a second partial reflecting film 36b. The light source unit 31 emits the light which may have any central wavelength and a minimal wavelength bandwidth capable of identifying the thickness of a sample. The optical coupler 33 is connected to the light source unit 31, the second collimator 35b and the light receiving unit 32 using the optical fiber, so that the optical coupler 33 is used to distribute or combine optical signals transmitted through the optical fiber. That is, the optical coupler 33 allows an optical signal emitted from the light source unit 31 to be transmitted to the collimator 35b, and allows a reference signal, an external sample signal and an internal sample signal, reflected from respective boundary surfaces of the object 40, to be measured and outputted outwards to be transmitted to a secondary interferometer in which the optical path difference is additionally compensated to generate an effective optical interference. The second collimator 35b converts the optical signal transmitted through the optical coupler 33 to a collimated light or focuses the optical signal reflected from the object 40 to be measured. Further, the beam-position transferring mirror 38 configured between the second collimator 35b and the object 40 to be measured is used to change an illumination position of the optical signal collimated and transmitted from the second collimator 35b. In addition, the objective lens 39 is provided to focus the optical signal transmitted with the illumination position thereof changed and then to illuminate the object 40 to be measured, and the second partial reflecting film 36b is provided between the objective lens 39 and the object 40 to be measured.

Further, the secondary interferometer coupled with the optical coupler 33 is configured to generate the effective optical interference by additionally compensating for the optical path difference if the optical path difference between the reference signal and the measuring signal from the sample is larger than the pseudo interference distance of the light source, wherein the secondary interferometer includes an optical interference generating portion 34 connected to the optical coupler 33 to additionally compensate for the optical path difference, thereby generating another optical interference; a first collimator 35a for converting an optical signal transmitted through the optical coupler 33 to a collimated light or focusing an optical signal reflected by a reflecting mirror 37 and a first partial reflecting film 36a.

The light receiving unit 32 is connected to the optical interference generating portion 34, and measures the height structure of the surface of the object 40 to be measured and the internal shape thereof from an interference spectrum of the object 40 to be measured, which is generated due to the optical path differences.

Although the optical interferometer system with a damped vibration and noise effect property according to the present invention may be implemented based on the optical fiber and the optical coupler as described above, it may be also implemented through a free-space optical device and a beam splitter.

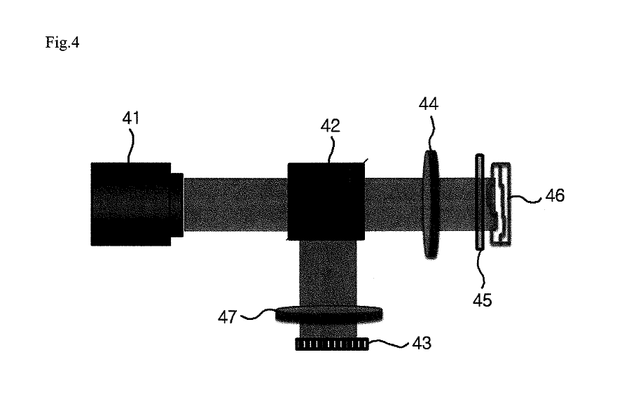

FIG. 4 is a configuration diagram of a free-space optical system based optical interference microscope system for effectively reducing vibration and noise. The free-space optical system based optical interference microscope system includes a light source unit 41, a beam splitter 42, a first lens 44, a partial reflecting film 45, an object 46 to be measured, a second lens 47, and a light receiving unit 43.

Here, the partial reflecting film 45 and the object 46 to be measured are vibrationally integrated and the optical path difference is adjustably generated, so that the vibration and noise may be effectively reduced.

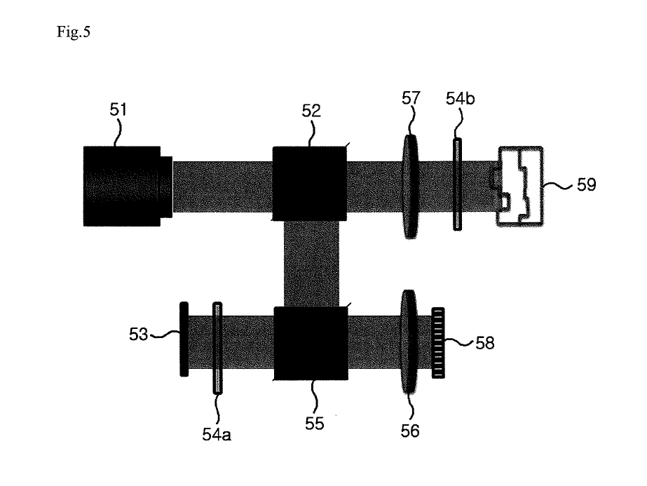

In addition, FIG. 5 is a configuration diagram of a free-space optical system based optical interference microscope system having an additional interferometer for compensating for an optical path difference. The free-space optical system based optical interference microscope system includes a light source unit 51, a first beam splitter 52, a first lens 57, a second partial reflecting film 54b, an object 59 to be measured, and a secondary interferometer. The secondary interferometer has a reflecting mirror 53, a first partial reflecting film 54a, a second beam splitter 55, a second lens 56, and a light receiving unit 58.

The invention in which the reference stage and the sample stage are integrated as described above may be implemented using a Michelson or Mach-Zehnder type optical interferometer as well as a Fizeau type optical interferometer.

Hereinafter, another optical interferometer system with a damped vibration and noise effect property according to the present invention will be described, in which the optical interferometer system includes a first optical interferometer for illuminating a first surface of an object to be measured with an optical signal and a second optical interferometer for illuminating a second surface opposite to the first surface with an optical signal.

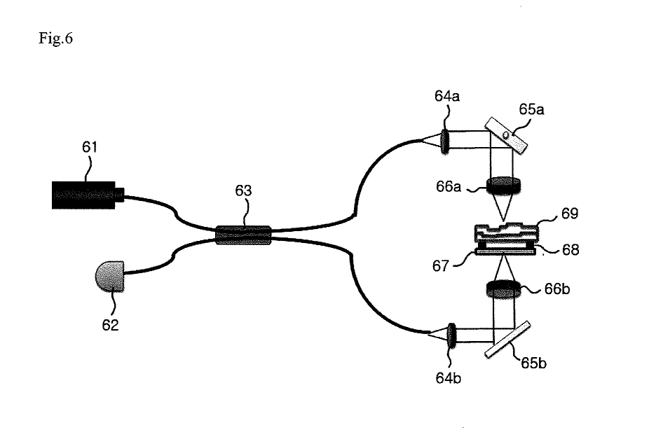

FIG. 6 is a configuration diagram of an optical interferometer system in which an additional reference reflecting film is attached onto an opposite surface of a sample to be measured using a space-separating attaching device, so that an optical path difference is formed to measure a surface structure of the sample and an internal shape thereof.

As shown in FIG. 6, the optical interferometer system is configured to include a light source unit 61, an optical coupler 63, and a light receiving unit 62. The light source unit 61 emits the light which may have any central wavelength and a minimal wavelength bandwidth capable of identifying the thickness of a sample. The optical coupler 63 is connected to the light source unit 61 and the first and second interferometers using the optical fiber, so that the optical coupler 63 is used to distribute or combine optical signals transmitted through the optical fiber. That is, the optical coupler 63 allows an optical signal emitted from the light source unit 61 to be transmitted to the first and second interferometers, and allows a reference signal, an external sample signal and an internal sample signal, reflected from respective boundary surfaces of the object 69, to be measured and outputted outwards to be transmitted to the light receiving unit 62. The light receiving unit 62 is connected to the optical coupler 63, and measures the height structure of the surface of the object 69 to be measured and the internal shape thereof from an interference spectrum of the object 69 to be measured, which is generated due to the optical path differences.

Here, the first interferometer for illuminating the first surface of the object 69 to be measured with an optical signal has a first collimator 64a, a first beam-position transferring mirror 65a, and a first objective lens 66a. The first collimator 64a converts the optical signal transmitted through the optical coupler 63 to a collimated light or focuses the optical signal reflected from the object 69 to be measured. Further, the first beam-position transferring mirror 65a configured between the first collimator 64a and the object 69 to be measured is used to change an illumination position of the optical signal collimated and transmitted from the first collimator 64a. In addition, the first objective lens 66a is provided to focus the optical signal transmitted with the illumination position thereof changed and then to illuminate the object 69 to be measured.

In addition, the second interferometer for illuminating a second surface opposite to the first surface of the object 69 to be measured with an optical signal has a second collimator 64b, a second beam-position transferring mirror 65b, a second objective lens 66b, and a reference reflecting film 67. The second collimator 64b converts the optical signal transmitted through the optical coupler 63 to a collimated light or focuses the optical signal reflected from the object 69 to be measured. Further, the second beam-position transferring mirror 65b configured between the second collimator 64b and the object 69 to be measured is used to change an illumination position of the optical signal collimated and transmitted from the second collimator 64b. In addition, the second objective lens 66b is provided to focus the optical signal transmitted with the illumination position thereof changed and then to illuminate the object 69 to be measured. The reference reflecting film 67 is integrated with the object 69 to be measured using a space-separating attaching device 68 to generate a reference signal.

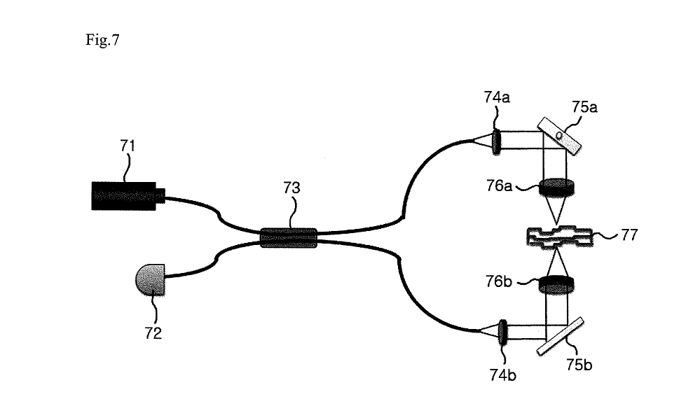

FIG. 7 is a configuration diagram of an optical interferometer system in which two opposite surfaces of a sample to be measured are used as two reflecting reference films for generating an optical interference so that a thickness structure of the sample is measured.

As shown in FIG. 7, the optical interferometer system is configured to include a light source unit 71, an optical coupler 73, and a light receiving unit 72. The light source unit 71 emits the light which may have any central wavelength and a minimal wavelength bandwidth capable of identifying the thickness of a sample. The optical coupler 73 is connected to the light source unit 71 and first and second interferometers using the optical fiber, so that the optical coupler 73 is used to distribute or combine optical signals transmitted through the optical fiber. That is, the optical coupler 73 allows an optical signal emitted from the light source unit 71 to be transmitted to the first and second interferometers, and allows a reference signal, an external sample signal and an internal sample signal, reflected from respective boundary surfaces of the object 77, to be measured and outputted outwards to be transmitted to the light receiving unit 72. The light receiving unit 72 is connected to the optical coupler 73, and measures the height structure of the surface of the object 77 to be measured and the internal shape thereof from an interference spectrum of the object 77 to be measured, which is generated due to the optical path differences.

Here, a first surface of the object to be measured, which is illuminated with the optical signal from the first interferometer, and a second surface of the object to be measured, which is illuminated with the optical signal from the second interferometer, are used as reference signal generating means for generating an optical interference.

The first interferometer for illuminating the first surface of the object 77 to be measured with an optical signal has a first collimator 74a, a first beam-position transferring mirror 75a, and a first objective lens 76a. The first collimator 74a converts the optical signal transmitted through the optical coupler 73 to a collimated light or focuses the optical signal reflected from the object 77 to be measured. Further, the first beam-position transferring mirror 75a configured between the first collimator 74a and the object 77 to be measured is used to change an illumination position of the optical signal collimated and transmitted from the first collimator 74a. In addition, the first objective lens 76a is provided to focus the optical signal transmitted with the illumination position thereof changed and then to illuminate the object 77 to be measured.

In addition, the second interferometer for illuminating a second surface opposite to the first surface of the object 77 to be measured with an optical signal has a second collimator 74b, a second beam-position transferring mirror 75b, and a second objective lens 76b. The second collimator 74b converts the optical signal transmitted through the optical coupler 73 to a collimated light or focuses the optical signal reflected from the object 77 to be measured. Further, the second beam-position transferring mirror 75b configured between the second collimator 74b and the object 77 to be measured is used to change an illumination position of the optical signal collimated and transmitted from the second collimator 74b. In addition, the second objective lens 76b is provided to focus the optical signal transmitted with the illumination position thereof changed and then to illuminate the object 77 to be measured.

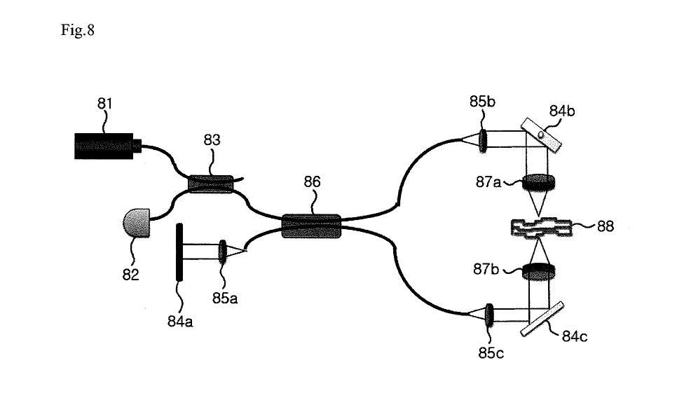

Further, FIG. 8 is a configuration diagram of an optical interference thickness measuring system having an additional interferometer for compensating for an optical path difference.

As shown in FIG. 8, the optical interference thickness measuring system is configured to include a light source unit 81, a first optical coupler 83, a second optical coupler 86, and a light receiving unit 82. The light source unit 81 emits the light which may have any central wavelength and a minimal wavelength bandwidth capable of identifying the thickness of a sample. The optical coupler 83 is connected to the light source unit 81 using the optical fiber, so that the optical coupler 83 is used to distribute or combine an optical signal transmitted through the optical fiber. That is, the first optical coupler 83 allows an optical signal emitted from the light source unit 81 to be transmitted to first and second interferometers, and allows a reference signal, an external sample signal and an internal sample signal, reflected from respective boundary surfaces of the object 88, to be measured and outputted outwards to be transmitted to the light receiving unit 82. The second optical coupler 86 is connected to the first optical coupler 83, a secondary interferometer, and the first and second interferometers. The light receiving unit 82 is connected to the optical coupler 83, and measures the height structure of the surface of the object 88 to be measured and the internal shape thereof from an interference spectrum of the object 88 to be measured, which is generated due to the optical path differences.

Here, a first surface of the object to be measured, which is illuminated with the optical signal from the first interferometer, and a second surface of the object to be measured, which is illuminated with the optical signal from the second interferometer, are used as reference signal generating means for generating an optical interference.

The first interferometer for illuminating the first surface of the object 88 to be measured with an optical signal has a second collimator 85b, a first beam-position transferring mirror 84b, and a first objective lens 87a. The second collimator 85b converts the optical signal transmitted through the second optical coupler 86 to a collimated light or focuses the optical signal reflected from the object 88 to be measured. Further, the first beam-position transferring mirror 84b configured between the second collimator 85b and the object 88 to be measured is used to change an illumination position of the optical signal collimated and transmitted from the second collimator 85b. In addition, the first objective lens 87a is provided to focus the optical signal transmitted with the illumination position thereof changed and then to illuminate the object 88 to be measured.

In addition, the second interferometer for illuminating a second surface opposite to the first surface of the object 88 to be measured with an optical signal has a third collimator 85c, a second beam-position transferring mirror 84c, and a second objective lens 87b. The third collimator 85c converts the optical signal transmitted through the second optical coupler 86 to a collimated light or focuses the optical signal reflected from the object 88 to be measured. Further, the second beam-position transferring mirror 84c configured between the third collimator 85c and the object 88 to be measured is used to change an illumination position of the optical signal collimated and transmitted from the third collimator 85c. In addition, the second objective lens 87b is provided to focus the optical signal transmitted with the illumination position thereof changed and then to illuminate the object 88 to be measured.

Further, the secondary interferometer for additionally compensating for the optical path difference to generate an effective optical interference is composed of a first collimator 85a connected to the second optical coupler 86, and a reflecting mirror 84a.

As described above, in the optical interferometer system shown in FIGS. 7 and 8, the first surface of the object to be measured, which is illuminated with the optical signal from the first interferometer, and the second surface of the object to be measured, which is illuminated with the optical signal from the second interferometer, are used as reference signal generating means for generating an optical interference. Further, the optical interference signals outputted from the first and second interferometers are forced to have an identical vibration and noise through the measuring process so that vibrations and noises of the respective optical interference signals are canceled from each other.

The optical interferometer system with a damped vibration and noise effect property according to the present invention allows the reference stage and the sample stage to exist in a spatially-identical space, so that the reference stage and the sample stage may be subject to an identical vibration or environmental variation, thereby effectively removing vibration and noise of the optical interferometer system.

According to the present invention so configured, the reference reflecting film is located on the opposite surface of the sample stage to obtain the thickness information of the sample, or two opposite surfaces of the sample stage are used to obtain the thickness information of the sample, thereby being capable of improving the accuracy and the efficiency of the measurement.

The optical interferometer system with damped vibration and noise effect property according to the present invention so configured has the following advantages.

First, the reference stage and the sample stage are subject to an identical vibration or environmental variation, so that vibrations and noises of the optical interferometer may be effectively removed.

Second, the direct attachment of the partial reflecting film and the object to be measured is used to effectively damp the vibration and noise effect, so that a high-resolution optical shape measuring system may be implemented.

Third, the reference reflecting film is located on the opposite surface of the sample stage to effectively obtain the thickness information of the sample, or two opposite surfaces of the sample stage are used to effectively obtain the thickness information of the sample.

As described above, it will be understood that the present invention may be implemented using modified embodiments without departing from the intrinsic characteristics of the present invention.

Accordingly, the aforementioned embodiments are considered not in limited standpoints but in illustrative standpoints. The scope of the present invention is not limited to the embodiment described and illustrated above but is defined by the appended claims. All differences within the equivalence to the scope will be considered to fall in the scope of the present invention.

1. An optical interferometer system with a damped vibration and noise effect property, comprising:
an optical interferometer having a reference signal generating means attached to be spaced apart from an object to be measured by a predetermined distance, wherein the optical interferometer allows a reference signal and a measuring signal reflected from each boundary surface of the object to be measured to have an identical vibration and noise so that the vibrations and noises of the reference and measuring signals are canceled from each other; and
a light receiving unit for measuring the object to be measured using an optical inference signal transmitted from the optical interferometer.

2. The optical interferometer system as claimed in claim 1, wherein the reference signal generating means is a partial reflecting film for reflecting a portion of an optical signal transmitted from its outside to generate the reference signal, the partial reflecting film allowing the other portion of the optical signal to pass therethrough to thereby generate the measuring signal reflected from at least one boundary surface among an exterior surface and an interior surface of the object to be measured.

3. The optical interferometer system as claimed in claim 1, wherein the optical interferometer further includes an optical coupler for outputting light onto the object to be measured, and the reference signal generating means is located at a position which is relatively closer to a spatial vibration tendency of the object to be measured rather than a spatial vibration tendency of the optical coupler.

4. The optical interferometer system as claimed in claim 1, further comprising a space-separating attaching means for attaching the reference signal generating means to be spaced apart from the object to be measured by a predetermined distance.

5. The optical interferometer system as claimed in claim 4, wherein the space-separating attaching means directly attaches the reference signal generating means and the object to be measured.

6. The optical interferometer system as claimed in claim 4, wherein the space-separating attaching means attaches the reference signal generating means to a support on which the object to be measured is located.

7. An optical interferometer system with a damped vibration and noise effect property, comprising:
an optical interferometer having a reference signal generating means attached to be spaced apart from an object to be measured by a predetermined distance, wherein the optical interferometer allows a reference signal and a measuring signal reflected from each boundary surface of the object to be measured to have an identical vibration and noise so that the vibrations and noises of the reference and measuring signals are canceled from each other;
a secondary interferometer for generating an optical interference to compensate for an optical path difference generated by the optical interferometer; and
a light receiving unit for measuring the object to be measured using optical inference signals transmitted from the optical interferometer and the secondary interferometer.

8. The optical interferometer system as claimed in claim 7, wherein the reference signal generating means is a partial reflecting film for reflecting a portion of an optical signal transmitted from its outside to generate the reference signal, the partial reflecting film allowing the other portion of the optical signal to pass therethrough to thereby generate the measuring signal reflected from at least one boundary surface among an exterior surface and an interior surface of the object to be measured.

9. The optical interferometer system as claimed in claim 7, wherein the optical interferometer further includes an optical coupler for outputting light onto the object to be measured, and the reference signal generating means is located at a position which is relatively closer to a spatial vibration tendency of the object to be measured rather than a spatial vibration tendency of the optical coupler.

10. The optical interferometer system as claimed in claim 7, further comprising a space-separating attaching means for attaching the reference signal generating means to be spaced apart from the object to be measured by a predetermined distance, wherein the space-separating attaching means directly attaches the reference signal generating means and the object to be measured or attaching the reference signal generating means and a support on which the object to be measured is located.

11. The optical interferometer system as claimed in claim 7, wherein if an optical path difference between the reference signal and the measuring signal is larger than a pseudo interference distance of a light source, the secondary interferometer additionally compensates for the optical path difference to generate an optical interference.

12. An optical interferometer system with a damped vibration and noise effect property, comprising:
a first optical interferometer having a reference signal generating means attached to a first surface of an object to be measured to be spaced apart by a predetermined distance, the first optical interferometer allowing a reference signal and a measuring signal reflected from each boundary surface of the object to be measured to have an identical vibration and noise so that the vibrations and noises of the reference and measuring signals are canceled from each other;
a second optical interferometer configured on a second surface opposite to the first surface of the object to be measured, thereby illuminating the second surface of the object to be measured with an optical signal transmitted from a light source; and
a light receiving unit for measuring the object to be measured using optical inference signals transmitted from the first and second optical interferometers.

13. An optical interferometer system with a damped vibration and noise effect property, comprising:
a first optical interferometer configured on a first surface of an object to be measured, thereby illuminating the first surface of the object to be measured with an optical signal transmitted from a light source;
a second optical interferometer configured on a second surface opposite to the first surface of the object to be measured, thereby illuminating the second surface of the object to be measured with an optical signal transmitted from a light source; and
a light receiving unit for measuring the object to be measured using optical inference signals transmitted from the first and second optical interferometers, wherein the first surface of the object to be measured, which is illuminated with the optical signal from the first optical interferometer, and the second surface of the object to be measured, which is illuminated with the optical signal from the second optical interferometer, are used as reference signal generating means for generating an optical interference.

14. An optical interferometer system with a damped vibration and noise effect property, comprising:
a first optical interferometer configured on a first surface of an object to be measured, thereby illuminating the first surface of the object to be measured with an optical signal transmitted from a light source;
a second optical interferometer configured on a second surface opposite to the first surface of the object to be measured, thereby illuminating the second surface of the object to be measured with an optical signal transmitted from a light source;
a secondary interferometer for generating an optical interference to compensate for optical path differences generated by the first and second optical interferometers; and
a light receiving unit for measuring the object to be measured using optical inference signals transmitted from the first and second optical interferometers and the secondary interferometer,
wherein the first surface of the object to be measured, which is illuminated with the optical signal from the first optical interferometer, and the second surface of the object to be measured, which is illuminated with the optical signal from the second optical interferometer, are used as reference signal generating means for generating an optical interference.

15. The optical interferometer system as claimed in claim 13, wherein each of the first and second optical interferometers further includes an optical coupler for outputting light onto the object to be measured, and the reference signal generating means is located at a position which is relatively closer to a spatial vibration tendency of the object to be measured rather than a spatial vibration tendency of the optical coupler.

16. The optical interferometer system as claimed in claim 14, wherein each of the first and second optical interferometers further includes an optical coupler for outputting light onto the object to be measured, and the reference signal generating means is located at a position which is relatively closer to a spatial vibration tendency of the object to be measured rather than a spatial vibration tendency of the optical coupler.
